(19) United States
(12) Patent Application Publication
(10) Pub. No.: US 2009/0293738 A1
(43) Pub. Date: Dec. 3, 2009

(54) Food Elevator for a Toaster or Grill

(75) Inventors: Gordon K. Russell, Etobicoke (CA); Clement Ching, Toronto (CA)

Correspondence Address: HONIGMAN MILLER SCHWARTZ & COHN LLP, 38500 WOODWARD AVENUE, SUITE 100, BLOOMFIELD HILLS, MI, 48304-5048, US

(73) Assignee: Hot Diggity Dogger Inc., Toronto (CA)

(21) Appl. No.: 12/130,325

(22) Filed: May 30, 2008

(51) Int. Cl. A47J 43/18

(52) U.S. Cl. 99/427

(57) ABSTRACT

A food elevator for a toaster or grill comprising a pair of elongate rail members and one or more handles secured to the rail members to facilitate the insertion and removal of the elevator into a toaster or grill. The rail members have depending therefrom first and second compartments. The first and second compartments have at least partially enclosed side and bottom surfaces such that the first compartment is capable of receiving and holding therein a frankfurter and the second compartment is capable of receiving and holding therein a frankfurter bun. The first compartment is generally dimensioned to hold and retain therein a frankfurter in an orientation generally perpendicular to the rail members and the second compartment is generally dimensioned to hold and retain therein a frankfurter bun in an orientation generally perpendicular to the rail members.

### FIELD OF THE INVENTION

This invention relates generally to the field of cooking and heating appliances, and in particular to a new and improved food elevator for a toaster, vertical grill or similar appliance.

### BACKGROUND OF THE INVENTION

Frankfurters and sausages have been popular foods in many countries around the world for a very long time. Due to their popularity, the manner of heating, cooking or preparing frankfurters and sausages is varied and includes, among other means, boiling, frying, grilling and barbecuing. In the past, there have been a number of attempts by different individuals to develop a specialized cooking appliance which is able to heat or cook a frankfurter or sausage quickly, efficiently and conveniently.

One such prior device that has been commercially marketed for cooking or heating frankfurters and sausages is a toaster or vertical grill having dedicated slots or openings designed to accept and heat the frankfurter. In some instances such toasters or grills have secondary slots or openings capable of receiving and heating a bun. An example of such a device is disclosed in U.S. Pat. No. 4,901,631 which issued on Feb. 20, 1990. That patent discusses a toaster or inverted grill having dedicated frankfurter and bun openings or slots that direct the frankfurter and bun into heating chambers having elements that are configured in such a manner so as to permit the frankfurter to be heated while simultaneously lightly toasting the bun.

Prior toasters or grills, such as that disclosed in U.S. Pat. No. 4,901,631, typically incorporate an elevator to lower and raise the frankfurter within the toaster. Such elevators may also include means to support a frankfurter and a bun. The elevator is often made of metal and is sufficiently rigid to permit the lowering of the elevator into the toaster so that the frankfurter and bun can be exposed to heating elements for cooking and toasting purposes. Commonly, once the frankfurter and bun are cooked or toasted to a desired degree mechanical or electromechanical means disengage the heating elements and raise the elevator, in manner similar to the way that a standard toaster “pops” when the heating cycle is complete. In some cases the elevator may be an integral part of the toaster or grill that cannot be removed, while in other instances the elevator is constructed such that it can be extracted from the toaster for cleaning purposes.

While elevators of the type disclosed in U.S. Pat. No. 4,901,631 provide a means by which a frankfurter and/or a bun can be lowered into or removed from a toaster's heating chamber, the nature of their structures presents an increased likelihood of users coming into contact with either the elevator or the heated frankfurter, causing burns to hands and fingers. The likelihood of a user becoming burned through the use of such toasters or grills is significantly greater than during the use of a standard toaster as frankfurters are typically heated to a higher temperature and for a longer length of time than a slice of bread. Accordingly, while grasping a toasted slice of bread may not inflict a burn upon a user, grasping a heated frankfurter can have significantly different results. Similarly, should the hand of the user contact the metallic elevator the resulting burn could be relatively serious. Since frankfurters and hot dogs are commonly enjoyed by children, the potential for burns takes on an even greater significance.

As a result, others have proposed the utilization of a removable elevator having cool-touch handles that allow the elevator to be completely removed from the toaster or vertical grill without the user's hand coming into contact with either the hot portions of the elevator or the heated frankfurter. Such elevators have generally been constructed in the form of an elongate rectangular box-like structure with the frankfurter and bun being sandwiched between two opposing sides of the elevator. Although presenting a means to somewhat reduce the likelihood of an individual becoming burned during use, such elevators are generally deficient in their ability to rigidly hold a frankfurter in place within the heating chamber, which can result in the frankfurter falling or tripping over within the chamber. If the frankfurter is not held in its desired location, it will not be evenly exposed to the internal heating elements of the toaster or grill and may not be consistently heated or cooked. Such elevators also sometimes result in a user inserting a frankfurter and bun into the elevator in such a manner that the bun is subjected to all or a portion of the heating elements intended for the frankfurter, and vice-versa, such that the bun becomes overcooked and the frankfurter is not sufficiently heated. There thus exists the need for an improved elevator for use in such applications.

### BRIEF DESCRIPTION OF THE INVENTION

Accordingly, the invention provides a food elevator for a toaster or vertical grill that helps to prevent an individual from becoming burned during use of the toaster, that helps to hold a frankfurter in its desired orientation when inserted into the toaster or grill, and that further helps to ensure that both the frankfurter and the bun are subjected to an adequate degree of cooking and toasting without burning.

In a further aspect the invention provides a food elevator for a toaster or grill, the elevator comprising a pair of elongate rail members having depending therefrom first and second compartments, said first and second compartments having at least partially enclosed side and bottom surfaces such that said first compartment is capable of receiving and holding therein a frankfurter and said second compartment is capable of receiving and holding therein a frankfurter bun; and, one or more handles secured to said rail members to facilitate the insertion and removal of said elevator into a toaster or grill, wherein said first compartment is dimensioned to hold and retain therein a frankfurter in an orientation generally perpendicular to said rail members and said second compartment is dimensioned to hold and retain therein a frankfurter bun in an orientation generally perpendicular to said rail members.

In another aspect the invention concerns a food elevator for a toaster or grill, the elevator comprising a pair of elongate rail members having depending therefrom first and second compartments, said first and second compartments having at least partially enclosed side and bottom surfaces such that said first compartment is capable of receiving and holding therein a frankfurter and said second compartment is capable of receiving and holding therein a frankfurter bun; and, one or more handles secured to said rail members to facilitate the insertion and removal of said elevator into a toaster or grill, wherein said first compartment is generally dimensioned to hold and retain therein a frankfurter in an orientation generally perpendicular to said rail members and said second compartment is generally dimensioned to hold and retain therein a frankfurter bun in an orientation generally perpendicular to said rail members, said first compartment further including inwardly directed support members, said support members assisting in maintaining the orientation of a frankfurter in said first compartment such that said frankfurter is held generally perpendicular to said rail members.

Further aspects and advantages of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show the preferred embodiments of the present invention which:

FIG. 1 is a side elevational view of a toaster or vertical grill having received therein a food elevator in accordance with one of the preferred embodiments of the present invention;

FIG. 2 is a left end view of the toaster shown in FIG. 1;

FIG. 3 is a top plan view of the toaster shown in FIG. 1;

FIG. 4 is a vertical sectional view of the toaster shown in FIG. 3 taken along the lines 4-4 of FIG. 3;

FIG. 5 is a side elevational view of the food elevator;

FIG. 6 is an upper side perspective view of the food elevator;

FIG. 7 is a top plan view of the food elevator;

FIG. 8 is a bottom view of the food elevator;

FIG. 9 is a right end view of the food elevator; and,

FIG. 10 is a left end view of the food elevator shown in FIG. 5.

### DESCRIPTION OF THE PREFERRED EMBODIMENT

The present invention may be embodied in a number of different forms. However, the specification and drawings that follow describe and disclose only some of the specific forms of the invention and are not intended to limit the scope of the invention as defined in the claims that follow herein.

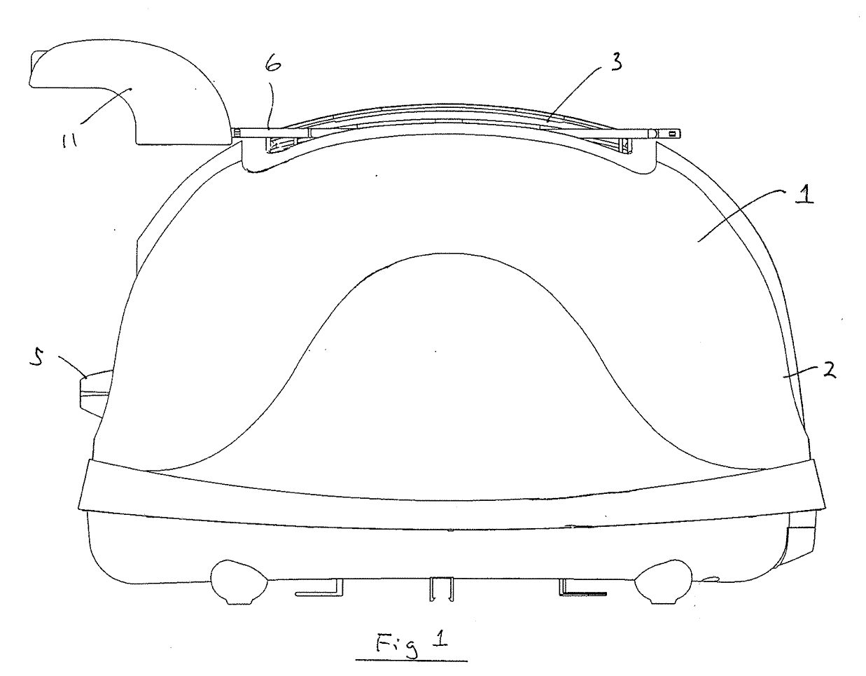

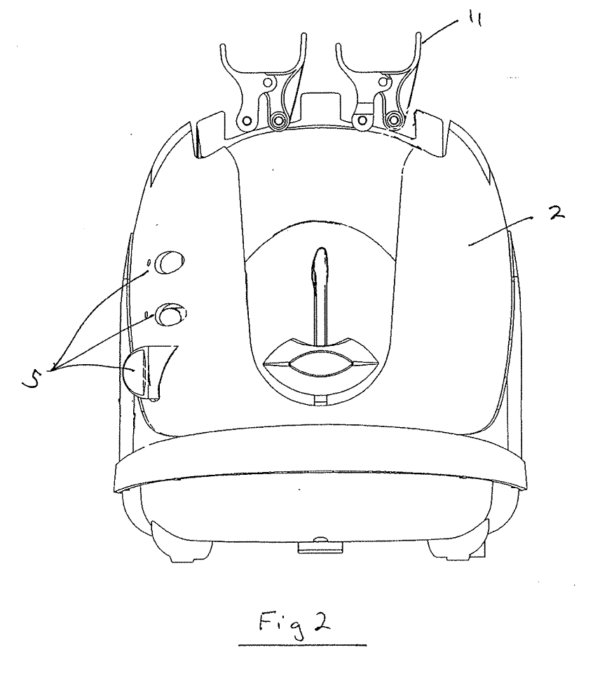

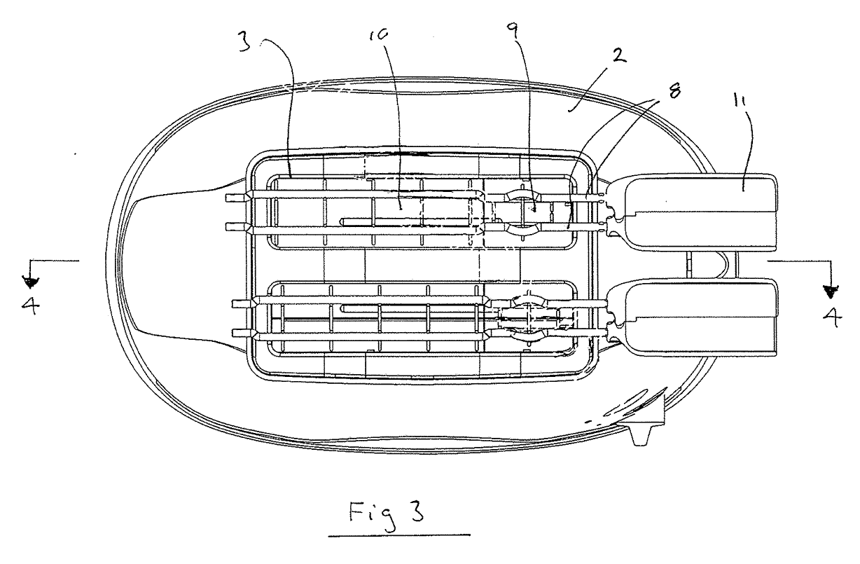

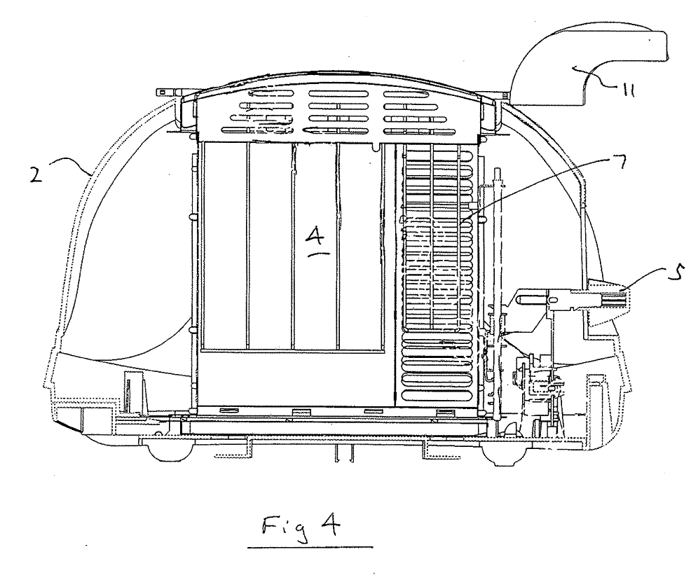

With reference to FIGS. 1 through 4, there is shown therein a vertical toaster or grill 1 which has been adapted and configured for use in association with a food elevator constructed in accordance with one of the preferred embodiments of the present invention. Aesthetically, toaster 1 looks much any standard toaster or vertical grill and is comprised generally of an outer housing 2 having one more slots or openings 3 in its upper surface that lead to one or more heating chambers 4. Typically toaster 1 would include control knobs and buttons 5 to control the operation of the appliance; including the heating level, cooking time, etc. In the case of the toaster shown in the attached Figures, two slots are located in the top or upper surface of the toaster, each leading to a separate and defined heating chamber 4. It will, however, be appreciate that in some instances the toaster may be fitted with a single slot, whereas in other instances 3, 4 or more slots may be present, much as is the case in standard toasters that are currently available.

Toaster 1 as shown in the attached drawings is designed specifically for heating and cooking frankfurters and frankfurter buns. As will be described in more detail at a later point, integral to the heating and cooking of the frankfurter is the use of a food elevator 6 which receives and holds a frankfurter and a bun in a particular orientation and in designated compartments or portions of heating chamber 4. That being the case, toaster 1, in the embodiment shown, is designed such that there is a greater concentration of electrical heating elements 7 in that portion of its interior heating chamber that receives the frankfurter than the portion of the heating chamber that receives the frankfurter bun. In some instances it may also be desirable to utilize different heating elements adjacent to the frankfurter and the bun such that not only is the concentration of the heating elements greater next to the frankfurter, but so too is the heat output of those elements. As a result, by concentrating heat in the portion of heating chamber 4 that receives the frankfurter, the toaster can be designed and configured such that a single heating cycle will heat the frankfurter to a desired temperature, while at the same time only lightly toasting the associated bun.

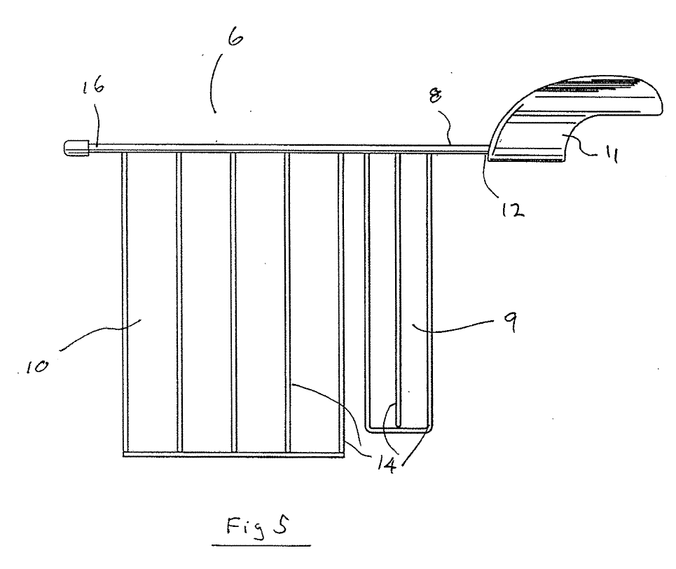

The particular structure of a preferred embodiment of a food elevator constructed according to the present invention is shown in further detail in FIGS. 5 through 10. As indicated in FIGS. 5 through 10, food elevator 6 is comprised generally of a pair of elongate rail members 8 having depending therefrom first and second compartments, 9 and 10 respectively. The first and second compartments have at least partially enclosed side and bottom surfaces such that first compartment 9 is capable of receiving and holding therein a frankfurter and second compartment 10 is capable of receiving and holding therein a frankfurter bun. Preferably second compartment 10 is of a size and configuration to enable the bun to be inserted therein when the bun is in an “open” configuration. Elongate rail members 8 have a first end 12 and a second end 16 with one or more handles 11 secured to first end 12 in order to facilitate the insertion and removal of the elevator into a toaster or grill.

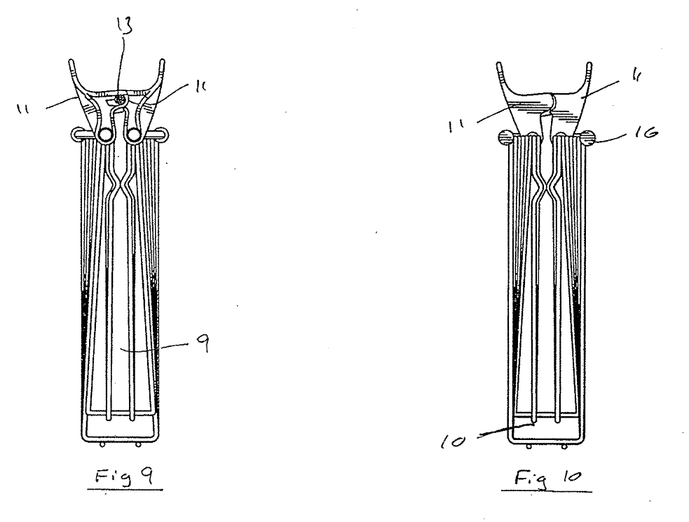

In order to accommodate and hold a frankfurter and bun while still allowing both to be subjected to heating and/or toasting when received within heating chamber 4 of toaster or grill 1, first compartment 9 and second compartment 10 are preferably formed from a number of spaced apart rod-like members or wires 14 that can be bent as desired to form a grid or cage-like enclosure. In the embodiment shown in the attached drawings elongate rail members 8 are also comprised of rod-like members or wires. It will, however, be appreciated that the rails and compartments may be comprised of a variety of other similar or functionally equivalent structures. Rail members 8 should have sufficient strength and rigidity to support the first and second compartments when the elevator is grasped and lifted by means of handles 11. Similarly, the rod-like members or wires 14 forming the first and second compartments will be of a sufficient strength and rigidity to support and hold the weight of a frankfurter and a bun. The material from which the wires are formed may be varied, however, should be sufficient to endure temperatures commonly encountered within the interior of a toaster or vertical grill without undue thermal expansion or loss of rigidity and strength. The opposing sides of the grid or “cage-like” structure forming first and second compartments 9 and 10 may be secured to rail members 8 through the use of adhesives, through welding, or by any one of a wide variety of different mechanical means. In the embodiment of the elevator shown in the attached drawings, rail members 8 are metallic and the first and second compartments are secured thereto through the use of welds. In addition, in this particular embodiment of the invention the handles 11 are rotatably attached to one another by means of a hinge pin 13 (see FIG. 9) that permits the handles to be squeezed together to separate rails 8 and effectively open compartments 9 and 10.

Preferably food elevator 6, and in particular first and second compartments 9 and 10, are constructed in a fashion that allows the compartments to hold a frankfurter and a bun in an orientation that is generally perpendicular to rail members 8. It will be appreciated from a thorough understanding of the invention that maintaining the frankfurter and bun in an orientation that is generally perpendicular to the rail members helps to ensure that both the frankfurter and the bun are maintained in a generally vertical orientation when inserted into slots 3 in the top of toaster or grill 1 and into heating chamber 4. The orientation of the frankfurter and the bun is important in order to help ensure that they are positioned correctly within heating chamber 4 and are subjected to electrical heating elements 7 in an efficient manner to allow for heating or cooking of the frankfurter and a light toasting of the bun. To that end, and to help maintain the orientation of the frankfurter in particular, in one of the preferred embodiments of the invention first compartment 9 includes inwardly directed support members 15 that help to hold and maintain the frankfurter perpendicular to rail members 8. In the embodiment that depicted in the drawings, inwardly directed support members 15 are comprised of inwardly bent portions of rod-like members or wires 14. In this embodiment there are two sets of opposed inwardly directed support members formed in first compartment 9 that together prevent excessive tipping or leaning of the frankfurter.

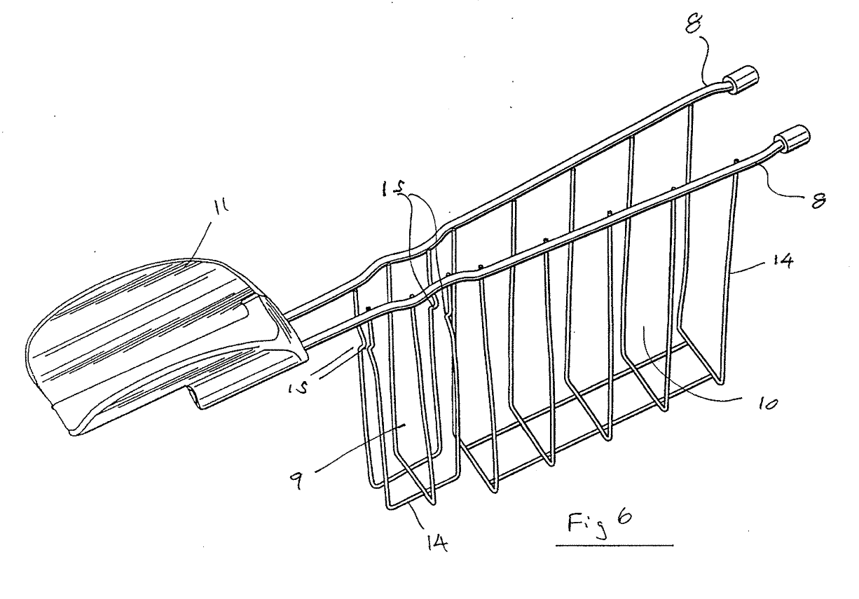

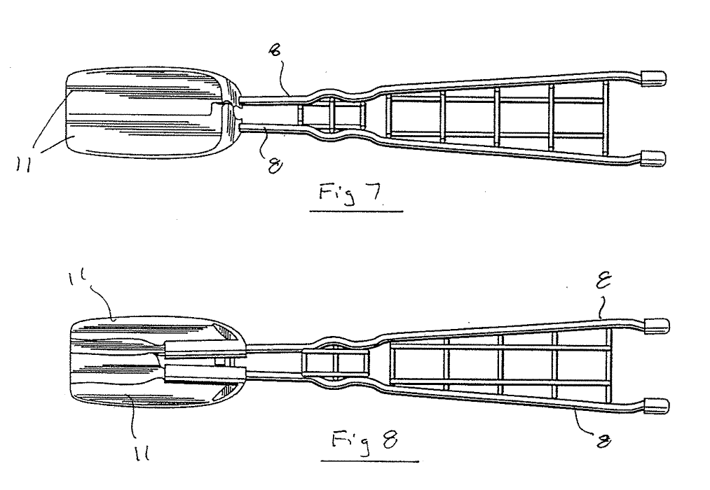

It will thus be appreciated that through the use of inwardly directed support members 15, when a frankfurter is inserted into first compartment 9 it will be held relatively securely in place and generally prevented from tipping beyond a pre-determined degree from perpendicular with respect to rail members 8. It will also be appreciated that by forming inwardly directed support members 15 through bending portions of rod-like members or wires 14 that form the sides of first compartment 9, the rigidity and strength of the wires or rod-like members forming first compartment 9 will be enhanced. It will also be appreciated that by situating inwardly directed support members 15 on opposite sides of first compartment 9, the support members will serve the further function of helping to prevent rail members 8 from being squeezed together by more than a pre-determined amount in order to help reduce the likelihood of excessively squeezing a frankfurter received within a first compartment 9 or a bun that may be received within second compartment 10. Finally, as shown in plan view in FIG. 7, rail members 8, at their point adjacent to first compartment 9, may be bent in a concave fashion to make it easier to insert a cylindrical shaped frankfurter between the rail members and into first compartment 9. It may also be desirable to orient the rail members such that they diverge in a direction away from handles 11 (See FIGS. 7 and 8). Doing so will permit the rail members to be closer together at first compartment 9 (having the result of helping to more securely hold a frankfurter in place) and further apart at second compartment 10 (having the effect of reducing the likelihood of squashing or over compressing the bun).

It will thus be appreciated from an understanding of the present invention that the food elevator described and disclosed herein provides a means to easily and securely hold a frankfurter and a bun and to allow for the insertion of both the frankfurter and the bun into an opening within a toaster or grill to permit heating and cooking of the frankfurter and toasting the bun. The elevator not only allows for the frankfurter and bun to be inserted into the toaster, but also permits both to be readily removed, after the cooking and toasting processes have completed, in a simple manner that avoids contact with both of the foods and that reduces the likelihood of burns to the hands of an operator. In addition, it will be appreciated that through the described structure of the food elevator the frankfurter will be securely held in an orientation that is generally perpendicular to the longitudinal axis of the elevator, and hence that is generally vertical when the elevator is inserted into the toaster. Maintaining the frankfurter in a vertical orientation is important from the standpoint of insuring an efficient and thorough cooking or heating of the frankfurter, to ensure that any drippings as a result of the heating of the frankfurter are directed to a dedicated catch tray within the toaster, and also to prevent the frankfurter from falling or tipping in one direction or the other which could result in the frankfurter becoming over cooked, insufficiently heated, or possibly stuck or jammed within the toaster. While not specifically discussed above, it will be understood by those of reasonable skill in the art that the described elevator structure could also be used for the toasting or cooking of other foodstuffs, aside from frankfurters and buns, including sausages, chicken breasts and other forms of meats and other food products.

It is to be understood that what has been described are the preferred embodiments of the invention and that it may be possible to make variations to these embodiments while staying within the broad scope of the invention. Some of these variations have been discussed while others will be readily apparent to those skilled in the art.

I claim:

1. A food elevator for a toaster or grill, the elevator comprising:
(i) a pair of elongate rail members having depending therefrom first and second compartments, said first and second compartments having at least partially enclosed side and bottom surfaces such that said first compartment is capable of receiving and holding therein a frankfurter and said second compartment is capable of receiving and holding therein a frankfurter bun; and,
(ii) one or more handles secured to said rail members to facilitate the insertion and removal of said elevator into a toaster or grill;
wherein said first compartment is dimensioned to hold and retain therein a frankfurter in an orientation generally perpendicular to said rail members and said second compartment is dimensioned to hold and retain therein a frankfurter bun in an orientation generally perpendicular to said rail members.

2. The food elevator as claimed in claim 1 wherein said first and said second compartments are formed from a grid of spaced apart wire-like members.

3. The food elevator as claimed in claim 1 wherein said first compartment includes inwardly directed support members, said support members assisting in maintaining the orientation of a frankfurter in said first compartment such that said frankfurter is held generally perpendicular to said rail members.

4. The food elevator as claimed in claim 2 wherein said first compartment includes inwardly directed support members, said support members assisting in maintaining the orientation of a frankfurter in said first compartment such that said frankfurter is held generally perpendicular to said rail members.

5. The food elevator as claimed in claim 4 wherein said inwardly directed support members comprise inwardly bent portions of said wire-like members.

6. The food elevator as claimed in claim 4 wherein said first compartment includes two pairs of opposed inwardly directed support members, said opposed inwardly directed support members situated on opposite sides of said first compartment to aid in maintaining a frankfurter in an orientation generally perpendicular to said rail members when the frankfurter is inserted into said first compartment.

7. The food elevator as claimed in claim 6 wherein said inwardly directed support members comprise inwardly bent portions of said wire-like members.

8. The food elevator as claimed in claim 6 wherein said inwardly directed supporting members further act to enhance the rigidity of said sides of said first compartment.

9. The food elevator as claimed in claim 1 wherein said elongate rail members diverge in a horizontal plane outwardly from a position adjacent said one or more handles.

10. A food elevator for a toaster or grill, the elevator comprising:
a pair of elongate rail members having depending therefrom first and second compartments, said first and second compartments having at least partially enclosed side and bottom surfaces such that said first compartment is capable of receiving and holding therein a frankfurter and said second compartment is capable of receiving and holding therein a frankfurter bun; and,
one or more handles secured to said rail members to facilitate the insertion and removal of said elevator into a toaster or grill;
wherein said first compartment is generally dimensioned to hold and retain therein a frankfurter in an orientation generally perpendicular to said rail members and said second compartment is generally dimensioned to hold and retain therein a frankfurter bun in an orientation generally perpendicular to said rail members, said first compartment further including inwardly directed support members, said support members assisting in maintaining the orientation of a frankfurter in said first compartment such that said frankfurter is held generally perpendicular to said rail members.
